(19) United States
(12) Patent Application Publication
(10) Pub. No.: US 2026/0296022 A1
(43) Pub. Date: Oct. 1, 2026

(54) PRINTING APPARATUS AND DISCHARGE HEAD MAINTENANCE METHOD

(71) Applicant: SCREEN Holdings Co., Ltd., Kyoto (JP)

(72) Inventor: Ikuhiko TAKAHAMA, Kyoto-shi (JP)

(21) Appl. No.: 19/538,110

(22) Filed: Feb. 12, 2026

(30) Foreign Application Priority Data
Mar. 25, 2025 (JP) 2025-049408

(51) Int. Cl. B41J 2/165; B41J 2/17

(52) U.S. Cl. CPC B41J 2/16511; B41J 2/16502; B41J 2/1714

(57) ABSTRACT

The cover member 51 performs the capping . In this capping, the cover member 51 covers the nozzles 421 from below by causing the ink receiving space 527 open upward to face the nozzle plane 42 from below while being stopped with respect to the discharge heads 44. The cover member 51 includes the liquid retaining member 541 for retaining the cleaning liquid, and the liquid retaining member 541 contacts the non-nozzle plane 43 during the execution of the capping. The ink can be removed from the non-nozzle plane 43 by diffusing the ink adhering to the non-nozzle plane 43 into the cleaning liquid. Since the cover member 51 is stopped with respect to the discharge heads 4 during the execution of the capping, the liquid retaining member 541 continues to continuously contact the non-nozzle plane 43. The ink can be effectively removed from the non-nozzle plane 43.

### CROSS REFERENCE TO RELATED APPLICATION

The disclosure of Japanese Patent Application No. 2025-049408 filed on Mar. 25, 2025 including specification, drawings and claims is incorporated herein by reference in its entirety.

### BACKGROUND

### Technical Field

This disclosure relates to a technique for maintaining a discharge head for discharging an ink from a nozzle.

### Background Art

In a printing apparatus for printing using a discharge head for discharging an ink from a nozzle in an inkjet method, it is important to maintain a nozzle surface where the nozzle is open in an appropriate condition as shown in JP2021-146697A, JP 5668467 and JP 6077185. Accordingly, in JP 2021-146697A, a cover member is used to enhance the airtightness of the nozzle surface where the nozzle is open. In JP 5668467, the ink is removed from the nozzle surface by wiping the nozzle surface (nozzle forming surface) by a wiper. In JP 6077185, a moisturizing cover is used to moisturize the nozzle surface.

### SUMMARY

Depending on a discharge head, a non-nozzle surface where the nozzle is not open is provided adjacent to a nozzle surface where the nozzle is open. Various techniques have been proposed as described above for the maintenance of the nozzle surface. On the other hand, no sufficient consideration has been made for the maintenance of the non-nozzle surface. However, it has been found that there is a phenomenon in which an ink mist floating in the air adheres to the non-nozzle surface, causing the non-nozzle surface to become contaminated with ink.

This disclosure was developed in view of the above problem and aims to enable an ink to be effectively removed from a non-nozzle surface of a discharge head.

A printing apparatus for discharging an ink to a printing medium according to the disclosure, comprises: a discharge head having a nozzle surface, in which a nozzle discharging the ink is open, and a non-nozzle surface, in which the nozzle is not open, provided adjacent to the nozzle surface; and a cover member including a bottom surface and a side wall standing from a peripheral edge part of the bottom surface, the cover member being formed with a space open upward, the cover member configured to execute capping for covering the nozzle from below by causing the space to face the nozzle surface from below while being stopped with respect to the discharge head, wherein the cover member includes a liquid retaining member retaining a cleaning liquid, the liquid retaining member contacts the non-nozzle surface during the execution of the capping.

A discharge head maintenance method according to the disclosure, comprises: performing capping by a cover member for a discharge head having a nozzle surface, in which a nozzle discharging the ink is open, and a non-nozzle surface, in which the nozzle is not open, provided adjacent to the nozzle surface; and the cover member including a bottom surface and a side wall standing from a peripheral edge part of the bottom surface, the cover member being formed with a space open upward, the capping being performed by covering the nozzle from below by causing the space to face the nozzle surface from below while the cover member is stopped with respect to the discharge head, the cover member including a liquid retaining member retaining a cleaning liquid, and the liquid retaining member contacting the non-nozzle surface during the execution of the capping.

In the disclosure (printing apparatus and discharge head maintenance method) thus configured, the cover member performs the capping. In this capping, the cover member covers the nozzle from below by causing the space open upward to face the nozzle surface from below while being stopped at the discharge head. Further, the cover member includes the liquid retaining member for retaining the cleaning liquid, and the liquid retaining member contacts the non-nozzle surface during the execution of the capping. Therefore, the ink can be removed from the non-nozzle surface by diffusing the ink adhering to the non-nozzle surface into the cleaning liquid. Moreover, since the cover member is stopped with respect to the discharge head during the execution of the capping, the liquid retaining member continues to continuously contact the non-nozzle surface. Thus, the ink can be effectively removed from the non-nozzle surface. For example, the contamination of the ink that cannot be removed by normal wiping can be removed.

As described above, according to the disclosure, an ink can be effectively removed from a non-nozzle surface of a discharge head.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a front view schematically showing a printing apparatus according to the disclosure.

FIG. 2A is a bottom view schematically showing the bottom surface of the head unit.

FIG. 2B is a side view schematically showing a side surface of the head unit.

FIG. 3A is a diagram schematically showing the configuration and operation of the maintenance unit.

FIG. 3B is a perspective view schematically showing a cover member provided in the maintenance unit.

FIG. 4A is a partial sectional view schematically showing a first example of the cover member and the discharge head at the retraction height.

FIG. 4B is a partial sectional view schematically showing the first example of the cover member and the discharge head at the capping height.

FIG. 5A is a partial sectional view schematically showing a second example of the cover member and the discharge head at the retraction height.

FIG. 5B is a partial sectional view schematically showing the second example of the cover member and the discharge head at the capping height.

FIG. 6A is a partial sectional view schematically showing a third example of the cover member and the discharge head at the retraction height.

FIG. 6B is a partial sectional view schematically showing the third example of the cover member and the discharge head at the capping height.

FIG. 7 is a partial sectional view schematically showing a fourth example of the cover member and the discharge head at the capping height.

FIG. 8A is a partial sectional view schematically showing a fifth example of the cover member and the discharge head at the retraction height

FIG. 8B is a partial sectional view schematically showing the fifth example of the cover member and the discharge head at the capping height.

FIG. 9A is a partial sectional view schematically showing a sixth example of the cover member and the discharge head at the retraction height

FIG. 9B is a partial sectional view schematically showing the sixth example of the cover member and the discharge head at the capping height.

FIG. 10A is a partial sectional view schematically showing a seventh example of the cover member and the discharge head at the retraction height,

FIG. 10B is a partial sectional view schematically showing the seventh example of the cover member and the discharge head at the capping height.

### DETAILED DESCRIPTION

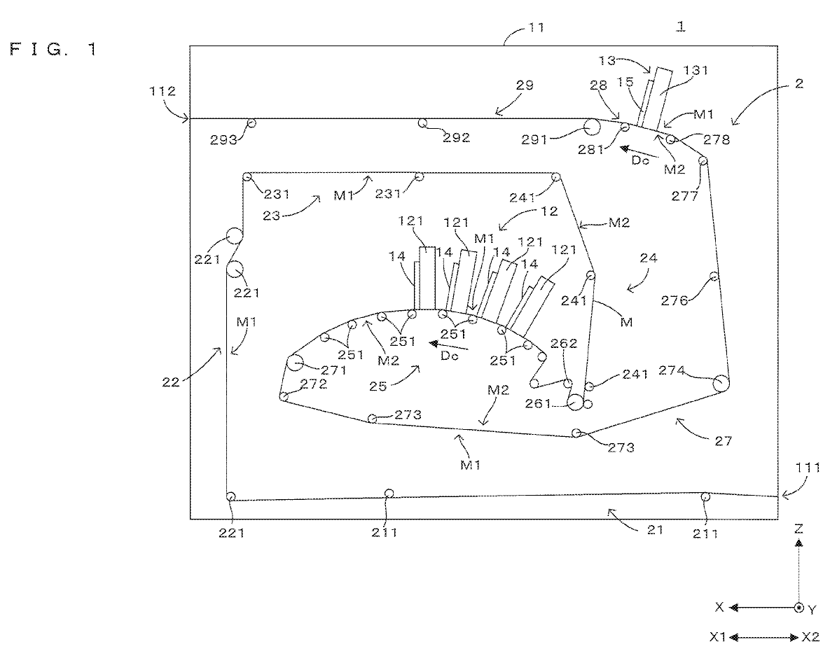

FIG. 1 is a front view schematically showing a printing apparatus according to the disclosure. In FIG. 1 and subsequent figures, an X direction, which is a horizontal direction, a Y direction, which is a horizontal direction orthogonal to the X direction, and a Z direction, which is a vertical direction, are appropriately shown. Further, one side X1 and another side X2 in the X direction are appropriately shown. Here, the one side X1 and the other side X2 are opposite to each other.

A printing apparatus 1 is provided with an enclosure 11, a color printer 12 arranged in the enclosure 11, a white printer 13 arranged above the color printer 12 in the enclosure 11 and a conveyor 2 for conveying a printing medium M by a plurality of rollers arranged in the enclosure 11. That is, the enclosure 11 accommodates the color printer 12, the white printer 13 and the conveyor 2.

The color printer 12 includes a plurality of (four) head units 121 arrayed in a moving direction of the printing medium M (direction from the other side X2 toward the one side X1) above the printing medium M being conveyed by the conveyor 2. The plurality of head units 121 include nozzles facing a front surface M1 of the printing medium M passing therebelow from above, and discharge color inks of mutually different colors in an inkjet method. Here, the color inks mean inks of colors other than white and include inks of cyan, magenta, yellow, black and the like. In this way, the plurality of head units 121 of the color printer 12 print a color image on the front surface M1 of the printing medium M by discharging the color inks to the front surface M1 of the printing medium M passing therebelow from above.

Further, the white printer 13 includes a single head unit 131 arranged above the printing medium M being conveyed by the conveyor 2. The head unit 131 includes nozzles facing the front surface M1 of the printing medium M passing therebelow from above and discharges a white ink from the nozzles in the inkjet method. In this way, the head unit 131 of the white printer 13 prints a white image on the front surface M1 of the printing medium M by discharging the white ink to the front surface M1 of the printing medium M passing therebelow from above.

A carry-in port 111 is open in a side wall on the other side X2 of the enclosure 11 and the printing medium M is carried into the enclosure 11 through the carry-in port 111. In contrast, the conveyor 2 includes a carry-in unit 21. The carry-in unit 21 includes a plurality of rollers 211 arrayed in the X direction below the color printer 12, and conveys the printing medium M carried in through the carry-in port 111 from the other side X2 toward the one side X1 while supporting the printing medium M by the plurality of rollers 211.

Further, the conveyor 2 includes an upward conveyor 22 provided on the one side X1 of the carry-in unit 21. The upward conveyor 22 includes a plurality of rollers 221 arrayed in the Z direction on the one side X1 of the color printer 12. This upward conveyor 22 conveys the printing medium M upward while supporting the printing medium M by the plurality of rollers 221 after changing the moving direction of the printing medium M from the direction toward the one side X1 to an upward direction by bending the printing medium M conveyed by the carry-in unit 21 upward by the roller 221 located at a lower end, among the plurality of rollers 221. In this way, the printing medium M is conveyed from a lower side to an upper side of the color printer 12 by the upward conveyor 22.

Further, the conveyor 2 includes an upper conveyor 23 provided above the color printer 12. The upper conveyor 23 includes a plurality of rollers 231 arrayed in the X direction above the color printer 12. This upper conveyor 23 conveys the printing medium M toward the other side X2 while supporting the printing medium M by the plurality of rollers 231 after the moving direction of the printing medium M is changed from the upward direction to a direction toward the other side X2 by bending the printing medium M conveyed from the upward conveyor 22 toward the other side X2 by the roller 231 located at an end on the one side X1, among the plurality of rollers 231.

Further, the conveyor 2 includes a downward conveyor 24 provided on the other side X2 of the upper conveyor 23. The downward conveyor 24 includes a plurality of rollers 241 arrayed in the Z direction on the other side X2 of the color printer 12. This downward conveyor 24 conveys the printing medium M downward while supporting the printing medium M by the plurality of rollers 241 after changing the moving direction of the printing medium M from the direction toward the other side X2 to a downward direction by bending the printing medium M conveyed by the upper conveyor 23 downward by the roller 241 located at an upper end, among the plurality of rollers 241. Among the plurality of rollers 241 of this downward conveyor 24, the roller 241 at the upper end is located above the respective head units 121 of the color printer 12, and the roller 241 at a lower end is located below the respective head units 121 of the color printer 12. That is, the downward conveyor 24 conveys the printing medium M from the upper side to the lower side of the color printer 12.

Further, the conveyor 2 includes a color conveyor 25 provided below the upper conveyor 23 and on the one side X1 of the downward conveyor 24. This color conveyor 25 includes a plurality of rollers 251 arrayed in the X direction and configured to contact a back surface M2 of the printing medium M, and the printing medium M conveyed from the downward conveyor 24 is supported below the color printer 12 by the plurality of rollers 251. In this way, the plurality of rollers 251 of the color conveyor 25 convey the printing medium M from the other side X2 toward the one side X1 while supporting the printing medium M from below by contacting the back surface M2 of the printing medium M conveyed from the downward conveyor 24 from below. The respective head units 121 of the color printer 12 discharge the color inks from above to the front surface M1 of the printing medium M being conveyed along the front surface M1 by the color conveyor 25.

At this time, the front surface M1 of the printing medium M being conveyed by the color conveyor 25 is facing upward, and the back surface M2 of the printing medium M is facing downward. In particular, the printing medium M is carried in through the carry-in port 111 with the front surface M1 thereof facing upward, and conveyed from the other side X2 to the one side X1 by the carry-in unit 21. The printing medium M having passed through the carry-in unit 21 is conveyed from the one side X1 to the other side X2 by the upper conveyor 23 in a state vertically inverted by the upward conveyor 22 and the upper conveyor 23. Thus, the front surface M1 of the printing medium M being conveyed by the upper conveyor 23 is facing downward. The printing medium M having passed through the upper conveyor 23 is conveyed from the other side X2 to the one side X1 by the color conveyor 25 in a state vertically inverted by the downward conveyor 24 and the color conveyor 25. Thus, the front surface M1 of the printing medium M being conveyed by the color conveyor 25 is facing upward.

Further, the conveyor 2 includes rollers 261, 262 for contacting the printing medium M on a side upstream of the color conveyor 25 in the moving direction of the printing medium M. The roller 261 is a drive roller for driving the printing medium M.

Furthermore, the conveyor 2 includes an inverting conveyor 27 for vertically inverting the printing medium M conveyed to the one side X1 from the color conveyor 25 twice. This inverting conveyor 27 includes a plurality of rollers 271, 272 arrayed in the Z direction on the one side X1 of the color conveyor 25 and configured to contact the back surface M2 of the printing medium M. Among the plurality of rollers 271, 272, the roller 271 at an upper end is a drive roller for driving the printing medium M. This roller 271 changes the moving direction of the printing medium M from the direction toward the one side X1 to the downward direction by bending the printing medium M conveyed from the color conveyor 25 downward. Further, the roller 272 at a lower end changes the moving direction of the printing medium M from the downward direction to the direction toward the other side X2 by bending the printing medium M conveyed from the roller 271 toward the other side X2. In this way, the printing medium M is vertically inverted by the rollers 271, 272 in contact with the back surface M2 of the printing medium M, whereby the back surface M2 of the printing medium M faces upward and the front surface M1 of the printing medium M faces downward.

Further, the inverting conveyor 27 includes a plurality of rollers 273 arrayed in the X direction below the color conveyor 25 and on the other side X2 of the roller 272 and configured to contact the back surface M2 of the printing medium M. These rollers 273 convey the printing medium M conveyed from the roller 272 from the one side X1 toward the other side X2. In this way, the printing medium M with the back surface M2 facing upward is conveyed from the one side X1 toward the other side X2 by the plurality of rollers 273 contacting the back surface M2 of the printing medium M.

Furthermore, the inverting conveyor 27 includes a plurality of rollers 274, 276 and 277 arrayed in the Z direction on the other side X2 of the plurality of rollers 273 and the downward conveyor 24 and configured to contact the back surface M2 of the printing medium M. Among the plurality of rollers 274 to 277, the roller 274 at a lower end changes the moving direction of the printing medium M from the direction toward the other side X2 to the upward direction by bending the printing medium M conveyed from the plurality of rollers 273 upward, and the roller 277 at an upper end changes the moving direction of the printing medium M from the upward direction to the direction toward the one side X1 by bending the printing medium M conveyed from the roller 274 by way of the roller 276 toward the one side X1. In this way, the printing medium M is vertically inverted by the rollers 274 to 277 contacting the back surface M2 of the printing medium M, whereby the front surface M1 of the printing medium M faces upward and the back surface M2 of the printing medium M faces downward.

Further, the inverting conveyor 27 includes a roller 278 arranged above the upper conveyor 23 and on the one side X1 of the roller 277 and configured to contact the back surface M2 of the printing medium M. The roller 278 conveys the printing medium M conveyed from the roller 277 from the other side X2 toward the one side X1. In this way, the printing medium M with the front surface M1 facing upward is conveyed from the other side X2 toward the one side X1 by the roller 278 contacting the back surface M2 of the printing medium M.

As just described, the inverting conveyor 27 conveys the printing medium M conveyed from the color conveyor 25 downward by the rollers 271, 272 and further vertically inverts the front surface M1 and the back surface M2 of the printing medium M by conveying the printing medium M with the moving direction of the printing medium M changed to the direction toward the other side X2 by the roller 272. Subsequently, the inverting conveyor 27 conveys the printing medium M from the one side X1 toward the other side X2 by the plurality of rollers 273 and, then, conveys the printing medium M upward by the rollers 274 to 277. Further, the inverting conveyor 27 vertically inverts the front surface M1 and the back surface M2 of the printing medium M again by changing the moving direction of the printing medium M to the direction toward the one side X1 by the roller 277 and conveys the printing medium M from the other side X2 toward the one side X1 by the roller 278.

In this way, the inverting conveyor 27 vertically inverts the front surface M1 and the back surface M2 of the printing medium M twice only by the rollers 271 to 278 contacting the back surface M2 of the printing medium M and rotating while having the back surface M2 wound thereon. That is, the inverting conveyor 27 can vertically invert the front surface M1 and the back surface M2 of the printing medium M twice without providing support members such as rollers and air turn bars on the side of the front surface M1 of the printing medium M at all.

Further, the conveyor 2 includes a white conveyor 28 provided above the upper conveyor 23 and further on the one side X1 than the roller 278 of the inverting conveyor 27. This white conveyor 28 includes a roller 281, and the printing medium M conveyed from the roller 278 of the inverting conveyor 27 is supported below the white printer 13 by the roller 281. As just described, the roller 281 of the white conveyor 28 conveys the printing medium M from the other side X2 toward the one side X1 while supporting the printing medium M from below by contacting the back surface M2 of the printing medium M conveyed from the roller 278 of the inverting conveyor 27 from below. Then, the head unit 131 of the white printer 13 discharges the white ink from above to the front surface M1 of the printing medium M conveyed along the front surface M1 by the white conveyor 28.

Furthermore, the conveyor 2 includes a carry-out unit 29 provided above the upper conveyor 23 and on the one side X1 of the white conveyor 28. The carry-out unit 29 includes a plurality of rollers 291, 292 and 293 arrayed in the X direction and configured to contact the back surface M2 of the printing medium M. The roller 291 is a drive roller for driving the printing medium M, and the rollers 292, 293 rotate according to the conveyance of the printing medium M. In contrast, a carry-out port 112 is open in a side wall on the one side X1 of the enclosure 11, and the plurality of rollers 291 to 293 of the carry-out unit 29 carry out the printing medium M through the carry-out port 112 by conveying the printing medium M from the other side X2 toward the one side X1 while contacting the back surface M2 of the printing medium M from below.

In the aforementioned printing apparatus 1, the conveyor 2 conveys the printing medium M in a conveying direction Dc (in other words, along a conveyance path) shown in FIG. 1 by the plurality of rollers. To the printing medium M being conveyed by the conveyor 2, the color printer 12 discharges the color inks to print a color image (color image printing) and the white printer 13 discharges the white ink to print a white image (white image printing). In such a printing apparatus 1, the color inks discharged from the respective head units 121 of the color printer 12 partially scatter as an ink mist. Further, the white ink discharged from the head unit 131 of the white printer 13 partially scatters as an ink mist.

Accordingly, the printing apparatus 1 is provided with a mist collection unit 14 for colleting the ink mist. As shown in FIG. 1, four mist collection units 14 respectively corresponding to the four head units 121 are provided. The mist collection unit 14 is arranged downstream of the corresponding head unit 121 in the conveying direction Dc and adjacent to this head unit 121. Further, a mist collection unit 15 is provided which is corresponding to the head unit 131. The mist collection unit 15 is arranged downstream of the head unit 131 in the conveying direction Dc and adjacent to this head unit 131. The mist collection units 14, 15 collect the ink mist included in the air by sucking the air.

As described above, the color printer 12 and the white printer 13 of the printing apparatus 1 include the head units 121, 131. Next, the head units 121, 131 are described. Note that these respective head units 121, 131 have a common basic configuration. Accordingly, one head unit 121 is described below and the other head units 121, 131 are not described. Further, the head units 121, 131 are slightly inclined according to the inclination of the printing medium M conveyed in the conveying direction Dc. However, inclinations of the head units 121, 131 are assumed to be slight, and described below with the inclination ignored.

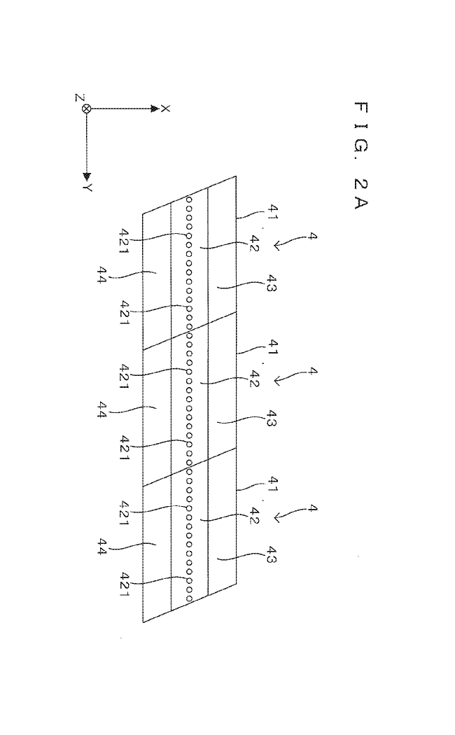

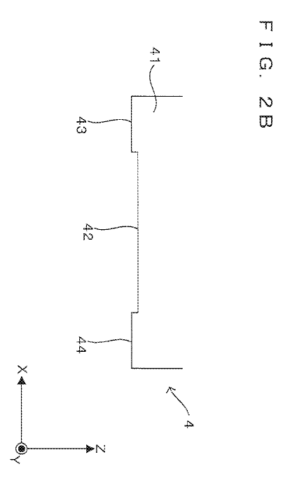

FIG. 2A is a bottom view schematically showing the bottom surface of the head unit, and FIG. 2B is a side view schematically showing a side surface of the head unit. In FIGS. 2A and 2B, the Y direction orthogonal to the X direction is shown besides the X direction and the Z direction. As shown in FIG. 2A, a plurality of discharge heads 4 for discharging the ink of the same color are arrayed in a row in the Y direction in the head unit 121. Note that an array mode of the discharge heads 4 is not limited to an example of FIG. 2A, and the plurality of discharge heads 4 may be arrayed in a staggered manner.

This discharge head 4 includes a housing 41, and the bottom surface of the housing 41 has a nozzle plane 42 and two non-nozzle planes 43, 44 provided on both sides of the nozzle plane 42 in the X direction. The nozzle plane 42 and the respective non-nozzle planes 43, 44 are parallel to each other, and face the front surface M1 of the printing medium M. As shown in FIG. 2B, the two non-nozzle planes 43, 44 arranged in the X direction are located at the same height (in other words, flush with each other). On the other hand, the nozzle plane 42 is located above the two non-nozzle planes 43, 44. That is, the two non-nozzle planes 43, 44 project further downward than the nozzle plane 42 between the two non-nozzle planes 43, 44. The nozzle plane 42 is, for example, made of silicon, and the non-nozzle planes 43, 44 are, for example, made of resin. The water repellency of the non-nozzle planes 43, 44 is lower than that of the nozzle plane 42.

In the nozzle plane 42, a plurality of nozzles 421 are arrayed in the Y direction and open. Note that, in the example of FIG. 2A, the plurality of nozzles 421 are arrayed in a row, but an array mode of these nozzles 421 is not limited to this example. For example, these nozzles 421 may be, for example, arrayed in a staggered manner in the Y direction. Each nozzle 421 provided in the nozzle plane 42 in this way discharges the ink toward the front surface M1 of the printing medium M. Note that the ink can be discharged by various inkjet techniques of a piezo-type or a thermal type.

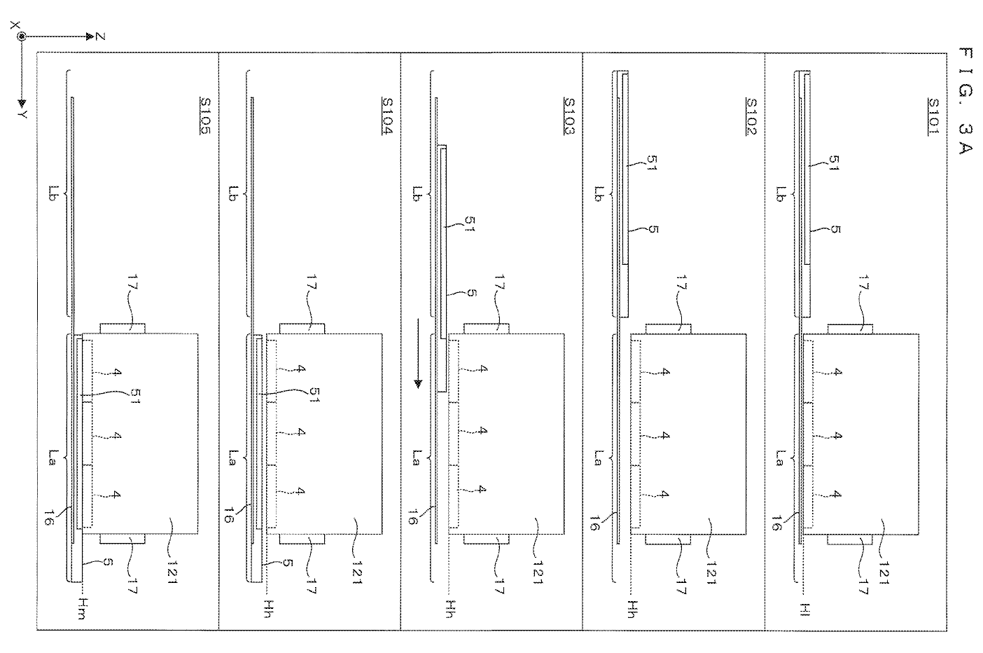

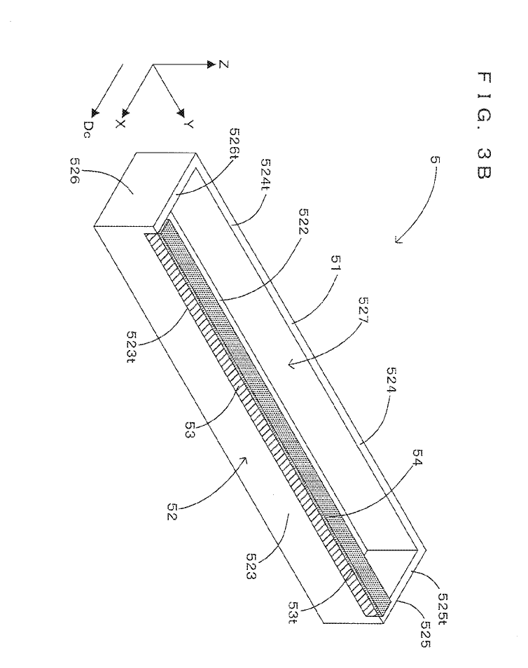

Further, the printing apparatus 1 is provided with a maintenance unit 5 for maintaining the respective discharge heads 4 (FIGS. 3A and 3B). Next, the maintenance unit 5 is described. Note that the maintenance unit 5 is arranged for each of the plurality of head units 121, 131, and the configurations and operations of the maintenance units 5 provided in the respective head units 121, 131 are common. Thus, one maintenance unit 5 is described here. Further, the maintenance unit 5 is slightly inclined according to the inclination of the head unit 121, 131 to be cleaned. However, inclinations of the maintenance units 5 are assumed to be slight, and described below with the inclination ignored.

FIG. 3A is a diagram schematically showing the configuration and operation of the maintenance unit 5, and FIG. 3B is a perspective view schematically showing a cover member 51 provided in the maintenance unit 5. The printing apparatus 1 is provided with the maintenance units 5, and the maintenance unit 5 includes the cover member 51. The cover member 51 includes a cover member body 52 having a rectangular shape in a plan view from the Z direction.

The cover member body 52 includes a horizontally provided bottom plate 522 and side plates 523, 524, 525 and 526 standing in the Z direction from a peripheral edge part (respective sides) of the bottom plate 522. The side plates 523,524 stand in the Z direction from both end parts in the X direction of the bottom plate 522 and are facing each other with a gap between them. These side plates 523,524 extend in the Y direction. The side plates 525, 526 stand in the Z direction from both end parts in the Y direction of the bottom plate 522 and are facing each other with a gap between them. These side plates 525, 526 extend in the X direction. In this way, the cover member body 52 has an ink receiving space 527 defined by the bottom plate 522 and the side plates 523 to 526. This ink receiving space 527 is open upward.

Of the side plates 523, 524, an upper end surface 523t of the side plate 523 on a downstream side in the conveying direction Dc is lower than an upper end surface 524t of the side plate 524 on an upstream side in the conveying direction Dc. Further, the upper end surface 523t of the side plate 523 is lower than an upper end surface 525t of the side plate 525 and an upper end surface 526t of the side plate 526. As just described, the upper end surface 523t of the side plate 523 is lower than the upper end surfaces 524t to 526t of the other side plates 524 to 526. On the other hand, the upper end surfaces 524t to 526t of the side plates 524 to 526 are flush with each other at the same height.

The cover member 51 includes an elastic member 53 arranged on the upper end surface 523t of the side plate 523. The elastic member 53 is made of rubber or the like, and is elastic. This elastic member 53 extends in the Y direction along the upper end surface 523t of the side plate 523, and is attached to the upper end surface 523t, for example, by an adhesive. An upper surface 53t of the elastic member 53 in a natural state where an external force is not acting to the elastic member 53 is flush with the upper end surfaces 524t to 526t of the side plates 524 to 526. However, a height relationship of these is not limited to this example.

Further, the cover member 51 includes a cleaning member 54 arranged on the upper surface 53t of the elastic member 53. The cleaning member 54 is a nonwoven fabric and has liquid absorbency for absorbing a liquid and liquid retention property for retaining the absorbed liquid. The cleaning member 54 extends in the Y direction along the upper surface 53t of the elastic member 53, extends to a surface of the side plate 523 on a +X direction side, and is attached to this surface on the +X direction side, for example, by an adhesive. As just described, the elastic member 53 and the cleaning member 54 are arranged on the upper end surface 523t of the side plate 523 on the downstream side in the conveying direction Dc, of the two side plates 523, 524 arrayed apart in the conveying direction Dc.

As shown in FIG. 3A, the printing apparatus 1 is provided with the maintenance unit 5 and a linear motion mechanism 16 for driving the maintenance unit 5 in the Y direction. This linear motion mechanism 16 moves the maintenance unit 5 between a facing position La and a retracted position Lb spaced apart from the facing position La in the Y direction. The maintenance unit 5 located at the facing position La is facing the plurality of discharge heads 4, whereas the maintenance unit 5 located at the retracted position Lb is not facing the plurality of discharge heads 4. Such a linear motion mechanism 16 can be, for example, constituted by a ball screw or a linear motor.

Further, to avoid interference with the maintenance unit 5, the plurality of discharge heads 4 can be integrally raised and lowered. That is, the printing apparatus 1 is provided with a linear motion mechanism 17 for driving the head unit 121 in the Z direction, and the linear motion mechanism 17 locates the head unit 121 at any one of a printing height Hl, a capping height Hm higher than the printing height H1 and a retraction height Hh higher than the capping height Hm. Here, the heights Hl, Hm and Hh are represented by the heights of the lower end surfaces of the discharge heads 4, i.e. the non-nozzle planes 43, 44. Such a linear motion mechanism 17 can be, for example, constituted by a ball screw or a linear motor.

In Step S101 of FIG. 3A, the maintenance unit 5 is located at the retracted position Lb, and the head unit 121 is located at the printing height Hl. That is, the head unit 121 approaches the front surface M1 of the printing medium M from above, and the maintenance unit 5 is retracted from the head unit 121 in the Y direction. In this state, each discharge head 4 discharges the ink to the front surface M1 of the printing medium M from the nozzles 421 and prints an image on this front surface M1.

In Step S102, the head unit 121 is raised from the printing height Hl to the retraction height Hh. In this way, a space, into which the maintenance unit 5 can enter, is formed in the Z direction at the facing position La right below the head unit 121. Note that the maintenance unit 5 is kept stopped at the retracted position Lb.

In Step S103, the maintenance unit 5 starts to move in the Y direction from the retracted position Lb toward the facing position La. In Step S104, the maintenance unit 5 reaches the facing position La and is stopped at the facing position La.

In Step S105, the head unit 121 is lowered from the retraction height Hh to the capping height Hm. In this way, the cover member 51 of the maintenance unit 5 stopped at the facing position La contacts the head unit 12 from below to cover the nozzle planes 42 of the plurality of discharge heads 4 from below (capping).

In a state where the capping is performed, the discharge heads 4 can perform purging to cause the ink to flow out downward from the nozzles 421 in the nozzle planes 42. By this purging, external matters (solidified ink and the like) clogged in the nozzles 421 is ejected from the nozzles 421.

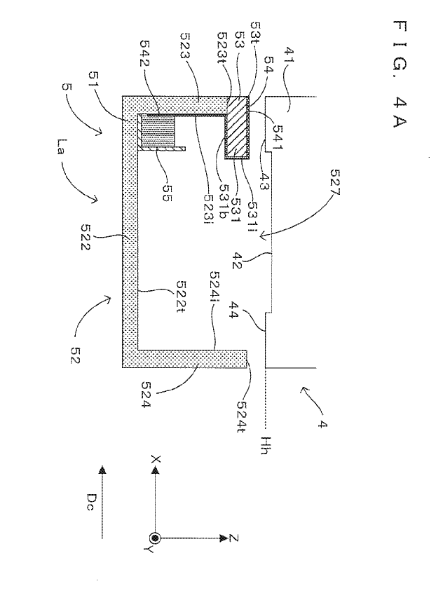

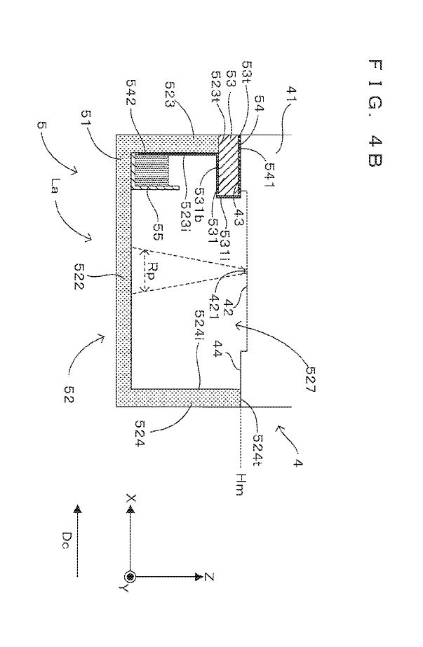

FIG. 4A is a partial sectional view schematically showing a first example of the cover member and the discharge head at the retraction height, and FIG. 4B is a partial sectional view schematically showing the first example of the cover member and the discharge head at the capping height. A state of Step S104 where the maintenance unit 5 at the facing position La is facing the discharge head 4 at the retraction height Hh from below is shown in FIG. 4A. A state of Step S105 where the maintenance unit 5 at the facing position La is facing the discharge head 4 at the capping height Hm from below (i.e. a state during the execution of the capping) is shown in FIG. 4B.

Two side plates 523, 524 respectively face the two non-nozzle planes 43, 44 from below. Of the two non-nozzle planes 43, 44, the non-nozzle plane 43 is provided on a downstream side in the conveying direction Dc, and the non-nozzle plane 44 is provided on an upstream side in the conveying direction Dc. Further, of the two side plates 523, 524, the side plate 523 provided on the downstream side in the conveying direction Dc is facing the non-nozzle plane 43 from below, and the side plate 524 provided on the upstream side in the conveying direction Dc is facing the non-nozzle plane 44 from below.

The ink receiving space 527 of the cover member body 52 faces the nozzles 421 (FIG. 2A) open in the nozzle plane 42 from below. The ink receiving space 527 is defined by an inner wall surface 523i of the side plate 523, an inner wall surface 524i of the side plate 524, an inner wall surface of the side plate 525, an inner wall surface of the side plate 526 and an upper surface 522t of the bottom plate 522. That is, the upper surface 522t of the bottom plate 522 corresponds to the bottom surface of the ink receiving space 527. As shown in FIG. 4B, the ink flowing out from the nozzles 421 by the purging falls down to the upper surface 522t of the bottom plate 522 through an ink passage range Rp.

Further, the cover member 51 includes a cleaning liquid tank 55 open upward. The cleaning liquid tank 55 stores a cleaning liquid for removing the ink from the non-nozzle plane 43. The cleaning liquid is, for example, a liquid composed of components other than a color material, in ink components (in other words, a transparent ink including no color material). The cleaning liquid tank 55 is arranged on the bottom plate 522 in the ink receiving space 527, and the upper end of the cleaning liquid tank 55 is located below the upper end surface 523t of the side plate 523. The cleaning liquid tank 55 is arranged at a position deviated from the ink passage range Rp, and adjacent to the side plate 523 on a side further downstream in the conveying direction Dc than the ink passage range Rp.

The cleaning member 54 extends from the elastic member 53 to the cleaning liquid tank 55. That is, the cleaning member 54 arranged in the conveying direction Dc along the upper surface 53t of the elastic member 53 extends downward along the inner wall surface 523i of the side plate 523 from an inner end (upstream end in the conveying direction Dc) of the upper surface 53t, and reaches the cleaning liquid tank 55. An end part of the cleaning member 54 having reached the cleaning liquid tank 55 is immersed in the cleaning liquid stored in the cleaning liquid tank 55. As described above, since the cleaning member 54 has liquid absorbency and liquid retention property, the cleaning member 54 absorbs the cleaning liquid stored in the cleaning liquid tank 55. The cleaning liquid absorbed by the cleaning member 54 moves upward to the upper surface 53t of the elastic member 53 along the inner wall surface 523i. In this way, the cleaning liquid is supplied to the cleaning member 54 on the upper end surface 523t of the elastic member 53. As just described, the cleaning member 54 integrally includes a liquid retaining member 541 provided on the upper surface 53t of the elastic member 53 and a liquid supplying member 542 extending from the liquid retaining member 541 to the cleaning liquid tank 55 to supply the cleaning liquid from the cleaning liquid tank 55 to the liquid retaining member 541.

As shown in FIG. 4B, the upper end surface 524t of the side plate 524 contacts the non-nozzle plane 44 from below while the cover member 51 is performing the capping. In the conveying direction Dc, a width of the upper end surface 524t of the side plate 524 is equal to or smaller than that of the non-nozzle plane 44. Further, in the conveying direction Dc, an existence range of the upper end surface 524t of the side plate 524 is included in that of the non-nozzle plane 44. Particularly, in the conveying direction Dc, an end on the upstream side of the upper end surface 524t of the side plate 524 coincides with an end on the upstream side of the non-nozzle plane 44, and an end on the downstream side of the upper end surface 524t of the side plate 524 is located upstream of (outside) an end on the downstream side of the non-nozzle plane 44. In other words, the side plate 524 is located upstream of (outside) the nozzle plane 42 in the conveying direction Dc.

Further, while the cover member 51 is performing the capping, the liquid retaining member 541 of the cleaning member 54 contacts the non-nozzle plane 43 from below. In the conveying direction Dc, a width of the liquid retaining member 541 is larger than that of the non-nozzle plane 43 contacted by the liquid retaining member 541. Further, in the conveying direction Dc, an existence range of the non-nozzle plane 43 is included in that of the liquid retaining member 541. Particularly, in the conveying direction Dc, an end on the downstream side of the liquid retaining member 541 coincides with an end on the downstream side of the non-nozzle plane 43, and an end on the upstream side of the liquid retaining member 541 is located upstream of (inside) an end on the upstream side of the non-nozzle plane 43. In other words, the liquid retaining member 541 projects toward the nozzle plane 42 (upstream side) from the non-nozzle plane 43 in the conveying direction Dc. However, the liquid retaining member 541 is arranged at the position deviated from the ink passage range Rp and located downstream of the ink passage range Rp in the conveying direction Dc.

The elastic member 53 supporting such a liquid retaining member 541 from below projects toward the upstream side (inner side) from the side plate 523 in the conveying direction Dc. In other words, the elastic member 53 includes a projecting part 531 projecting toward the upstream side (inner side) from the side plate 523 in the conveying direction Dc. The upper surface 53t of the elastic member 53 including the upper surface of the projecting part 531 projects further toward the upstream side (inner side) than the inner wall surface 523i (side surface on the upstream side) of the side plate 523 in the conveying direction Dc. In the conveying direction Dc, a lower surface 531b of the projecting part 531 extends toward the downstream side from the lower end of an inner side surface 531i (end surface on the upstream side) of the elastic member 53 (projecting part 531), and reaches the inner wall surface 523i of the side plate 523. In other words, the lower surface 531b of the projecting part 531 projects toward the upstream side in the conveying direction Dc from the inner wall surface 523i of the side plate 523. The cleaning liquid tank 55 is arranged below the projecting part 531 and faces the lower surface 531b of the projecting part 531 from below.

The cleaning member 54 extends to the cleaning liquid tank 55 via such a projecting part 531. That is, the cleaning member 54 arranged in the conveying direction Dc along the upper surface 53t of the elastic member 53 extends downward along the inner side surface 531i of the elastic member 53 from the inner end (upstream end in the conveying direction Dc) of the upper surface 53t, and reaches the lower end of the inner side surface 531i. Further, the cleaning member 54 extends toward the downstream side in the conveying direction Dc along the lower surface 531b from the lower end of the inner side surface 531i, and reaches the inner wall surface 523i of the side plate 523. The cleaning member 54 having reached the inner wall surface 523i of the side plate 523 extends downward along the inner wall surface 523i of the side plate 523 and reaches the cleaning liquid tank 55. The end part of the cleaning member 54 having reached the cleaning liquid tank 55 is immersed in the cleaning liquid stored in the cleaning liquid tank 55. In other words, the liquid supplying member 542 is provided from the cleaning liquid tank 55 to the upper surface 53t of the elastic member 53 via the inner wall surface 523i of the side plate 523 and the lower surface 531b and the inner side surface 531i of the projecting part 531. This liquid supplying member 542 supplies the cleaning liquid stored in the cleaning liquid tank 55 to the liquid retaining member 541 arranged on the upper surface 53t of the elastic member 53.

As shown in FIG. 4B, while the cover member 51 is performing the capping, the elastic member 53 presses the liquid retaining member 541 of the cleaning member 54 against the non-nozzle plane 43 while being elastically deformed. In this way, the liquid retaining member 541 pressed against the non-nozzle plane 43 continuous to stop with respect to the non-nozzle plane 43 during the capping. Therefore, the ink adhering to the non-nozzle plane 43 is diffused into the cleaning liquid retained in the liquid retaining member 541 stopped while being held in contact with the non-nozzle plane 43. Further, the liquid supplying member 542 can supply the cleaning liquid from the cleaning liquid tank 55 to the liquid retaining member 541.

In the first example described above, the cover member 51 performs the capping (Step S105 of FIG. 3A, FIG. 4B). In this capping, the cover member 51 covers the nozzles 421 from below by causing the ink receiving space 527 (space) open upward to face the nozzle plane 42 (nozzle surface) from below while being stopped with respect to the discharge heads 44. Further, the cover member 51 includes the liquid retaining member 541 for retaining the cleaning liquid, and the liquid retaining member 541 contacts the non-nozzle plane 43 (non-nozzle surface) during the execution of the capping. Therefore, the ink can be removed from the non-nozzle plane 43 by diffusing the ink adhering to the non-nozzle plane 43 into the cleaning liquid. Moreover, since the cover member 51 is stopped with respect to the discharge heads 4 during the execution of the capping, the liquid retaining member 541 continues to continuously contact the non-nozzle plane 43. Therefore, the ink can be effectively removed from the non-nozzle plane 43.

Further, the discharge head 4 has the non-nozzle plane 43 (first non-nozzle surface) and the non-nozzle plane 44 (second non-nozzle surface). In the conveying direction Dc of the printing medium M, the non-nozzle plane 43 is arranged downstream of (on a first side of) the non-nozzle plane 42, and the non-nozzle plane 44 is arranged upstream of (on a second side of) the nozzle plane 42. The cover member 51 has the upper end surface 523t (first facing part) and the upper end surface 524t (second facing part). During the capping, the upper end surface 523t is facing the non-nozzle plane 43 and the upper end surface 524t is facing the non-nozzle plane 44. The liquid retaining member 541 is arranged only on the upper end surface 523t, of the upper end surfaces 523t, 524t, and the liquid retaining member 541 arranged on the upper end surface 523t contacts the non-nozzle plane 43 during the execution of the capping. Such a configuration is effective, such as when there is a difference in degree of contamination between the non-nozzle planes 43 and 44. That is, the ink can be removed from the non-nozzle plane 43 by bringing the liquid retaining member 541 into contact with the non-nozzle plane 43 having a large degree of contamination. In this way, necessary maintenance can be performed for the non-nozzle plane 43 while the number of the cleaning member 54 (liquid retaining member 541) is suppressed.

Further, the mist collection units 14, 15 (mist collectors) are provided which suck the misty ink. The mist collection unit 14, 15 is arranged downstream of the discharge heads 4 in the conveying direction Dc. In such a configuration, an airflow of the ink mist sucked by the mist collection unit 14, 15 is generated near the non-nozzle plane 43. Thus, the degree of contamination of the non-nozzle plane 43 is larger as compared to the non-nozzle plane 44. Accordingly, the ink can be removed from the non-nozzle plane 43 by bringing the liquid retaining member 541 into contact with the non-nozzle plane 43. In this way, necessary maintenance can be performed for the non-nozzle plane while the number of the cleaning member 54 (liquid retaining member 541) is suppressed.

Further, the cover member 51 further includes the cleaning liquid tank 55 (cleaning liquid storage) for storing the cleaning liquid and the liquid supplying member 542 extending from the cleaning liquid tank 55 to the liquid retaining member 541. The liquid supplying member 542 feeds the cleaning liquid from the cleaning liquid tank 55 to the liquid retaining member 541. In such a configuration, a sufficient amount of the cleaning liquid required to remove the ink from the non-nozzle plane 43 can be supplied to the liquid retaining member 541 by the liquid supplying member 542.

Further, during the execution of the capping, the discharge head 41 performs the purging to cause the ink to flow out toward the ink receiving space 527 from the nozzles 421. The cleaning liquid tank 55 is provided at the position deviated from the ink passage range Rp (range) in which the ink flowing out from the nozzles 421 toward the ink receiving space 527 by the purging passes. In such a configuration, the contamination of the cleaning liquid tank 55 by the ink flowing out from the nozzles 421 by the purging can be suppressed. As a result, the ink can be efficiently removed from the non-nozzle plane 43 by supplying the clean cleaning liquid to the liquid retaining member 541.

Further, the cover member 51 includes the elastic member 53 having elasticity. The elastic member 53 is arranged below the liquid retaining member 541 and supports the liquid retaining member 541 from below. During the execution of the capping, the cleaning member 54 presses the liquid retaining member 541 against the non-nozzle plane 43 by an elastic force. In such a configuration, the ink can be efficiently removed from the non-nozzle plane 43 by firmly pressing the liquid retaining member 541 against the non-nozzle plane 43 by the elastic force of the elastic member 53.

Further, the above embodiment is suitable for the printing apparatus 1 in which the water repellency of the non-nozzle plane 43 is lower than that of the nozzle plane 42. That is, the ink easily adheres to the non-nozzle plane 43 low in water repellency, whereas the ink can be effectively removed from the non-nozzle plane 43.

Further, the cover member 51 is provided with the projecting part 531 (elastic member 53) provided on the upper end surface 523t (upper end) of the side plate 523 (side wall) to project inward from the peripheral edge of the ink receiving space 527 (i.e. the inner wall surface 523i of the side plate 523). The cleaning liquid tank 55 is arranged below the projecting part 531. The liquid retaining member 541 is provided on the upper surface 53t of the elastic member 53 including the upper surface of the projecting part 531. The liquid supplying member 542 extending from the liquid retaining member 541 is provided along the lower surface 531b of the projecting part 531 from the inner side surface 531i (side surface) of the projecting part 531 and reaches the cleaning liquid tank 55. In such a configuration, the contamination of the liquid supplying member 542 by the ink can be suppressed. As a result, the ink can be efficiently removed from the non-nozzle plane 43 by supplying the clean cleaning liquid to the liquid retaining member 541.

Note that even if the width of the liquid retaining member 541 is smaller than that of the non-nozzle plane 43 in the first example, similar effects can be achieved. That is, the cover member 51 may be so configured that the existence range of the liquid retaining member 541 is included in that of the non-nozzle plane 43 in the conveying direction Dc.

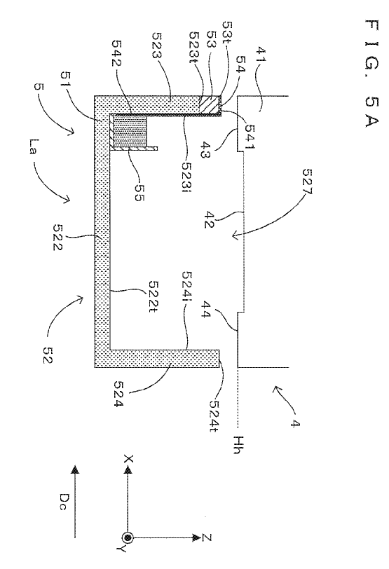

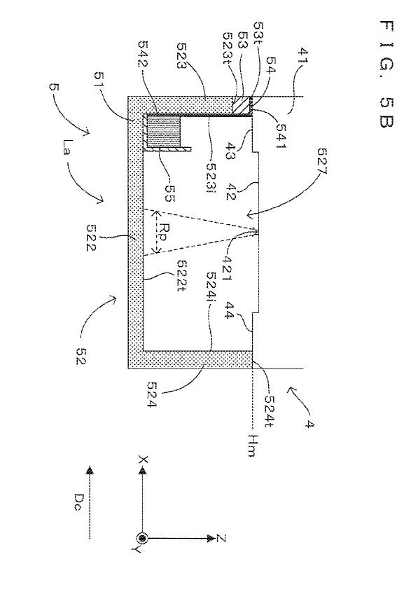

FIG. 5A is a partial sectional view schematically showing a second example of the cover member and the discharge head at the retraction height, and FIG. 5B is a partial sectional view schematically showing the second example of the cover member and the discharge head at the capping height. The state of Step S104 where the maintenance unit 5 at the facing position La is facing the discharge head 4 at the retraction height Hh from below is shown in FIG. 5A. The state of Step S105 where the maintenance unit 5 at the facing position La is facing the discharge head 4 at the capping height Hm from below (i.e. the state during the execution of the capping) is shown in FIG. 5B.

Two side plates 523, 524 respectively face the two non-nozzle planes 43, 44 from below. Of the two non-nozzle planes 43, 44, the non-nozzle plane 43 is provided on the downstream side in the conveying direction Dc, and the non-nozzle plane 44 is provided on the upstream side in the conveying direction Dc. Further, of the two side plates 523, 524, the side plate 523 provided on the downstream side in the conveying direction Dc is facing the non-nozzle plane 43 from below, and the side plate 524 provided on the upstream side in the conveying direction Dc is facing the non-nozzle plane 44 from below.

The ink receiving space 527 of the cover member body 52 faces the nozzles 421 (FIG. 2A) open in the nozzle plane 42 from below. The ink receiving space 527 is defined by the inner wall surface 523i of the side plate 523, the inner wall surface 524i of the side plate 524, the inner wall surface of the side plate 525, the inner wall surface of the side plate 526 and the upper surface 522t of the bottom plate 522. That is, the upper surface 522t of the bottom plate 522 corresponds to the bottom surface of the ink receiving space 527. As shown in FIG. 5B, the ink flowing out from the nozzles 421 by the purging falls down to the upper surface 522t of the bottom plate 522 through the ink passage range Rp.

Further, the cover member 51 includes the cleaning liquid tank 55 open upward. The cleaning liquid tank 55 stores the cleaning liquid for removing the ink from the non-nozzle plane 43. The cleaning liquid is, for example, a liquid composed of components other than a color material in ink components (in other words, a transparent ink including no color material). The cleaning liquid tank 55 is arranged on the bottom plate 522 in the ink receiving space 527, and the upper end of the cleaning liquid tank 55 is located below the upper end surface 523t of the side plate 523. The cleaning liquid tank 55 is arranged at the position deviated from the ink passage range Rp, and adjacent to the side plate 523 on the side further downstream in the conveying direction Dc than the ink passage range Rp.

The cleaning member 54 extends from the elastic member 53 to the cleaning liquid tank 55. That is, the cleaning member 54 arranged in the conveying direction Dc along the upper surface 53t of the elastic member 53 extends downward along the inner wall surface 523i of the side plate 523 from the inner end (upstream end in the conveying direction Dc) of the upper surface 53t, and reaches the cleaning liquid tank 55. The end part of the cleaning member 54 having reached the cleaning liquid tank 55 is immersed in the cleaning liquid stored in the cleaning liquid tank 55. As described above, since the cleaning member 54 has liquid absorbency and liquid retention property, the cleaning member 54 absorbs the cleaning liquid stored in the cleaning liquid tank 55. The cleaning liquid absorbed by the cleaning member 54 moves upward to the upper surface 53t of the elastic member 53 along the inner wall surface 523i. In this way, the cleaning liquid is supplied to the cleaning member 54 on the upper end surface 523t of the elastic member 53. As just described, the cleaning member 54 integrally includes the liquid retaining member 541 provided on the upper surface 53t of the elastic member 53 and the liquid supplying member 542 extending from the liquid retaining member 541 to the cleaning liquid tank 55 to supply the cleaning liquid from the cleaning liquid tank 55 to the liquid retaining member 541.

As shown in FIG. 5B, the upper end surface 524t of the side plate 524 contacts the non-nozzle plane 44 from below while the cover member 51 is performing the capping. In the conveying direction Dc, the width of the upper end surface 524t of the side plate 524 is equal to or smaller than that of the non-nozzle plane 44. Further, in the conveying direction Dc, the existence range of the upper end surface 524t of the side plate 524 is included in that of the non-nozzle plane 44. Particularly, in the conveying direction Dc, the end on the upstream side of the upper end surface 524t of the side plate 524 coincides with the end on the upstream side of the non-nozzle plane 44, and the end on the downstream side of the upper end surface 524t of the side plate 524 is located upstream of (outside) the end on the downstream side of the non-nozzle plane 44. In other words, the side plate 524 is located upstream of (outside) the nozzle plane 42 in the conveying direction Dc.

Further, as shown in FIG. 5B, the liquid retaining member 541 of the cleaning member 54 contacts the non-nozzle plane 43 from below. In the conveying direction Dc, the width of the liquid retaining member 541 is equal to or smaller than that of the non-nozzle plane 43 contacted by the liquid retaining member 541. Further, in the conveying direction Dc, the existence range of the liquid retaining member 541 is included in that of the non-nozzle plane 43. Particularly, in the conveying direction Dc, the end on the downstream side of the liquid retaining member 541 coincides with the end on the downstream side of the non-nozzle plane 43, and the end on the upstream side of the liquid retaining member 541 is located downstream of (outside) the end on the upstream side of the non-nozzle plane 43. In other words, the liquid retaining member 541 is located downstream of (outside) the nozzle plane 42 in the conveying direction Dc.

Further, as shown in FIG. 5B, the elastic member 53 presses the liquid retaining member 541 of the cleaning member 54 against the non-nozzle plane 43 while being elastically deformed. In this way, the liquid retaining member 541 pressed against the non-nozzle plane 43 continues to be stopped with respect to the non-nozzle plane 43 throughout the execution of the capping. Therefore, the ink adhering to the non-nozzle plane 43 is diffused into the cleaning liquid retained in the liquid retaining member 541 stopped in contact with the non-nozzle plane 43. Further, the liquid supplying member 542 can supply the cleaning liquid from the cleaning liquid tank 55 to the liquid retaining member 541.

In the second example described above, the cover member 51 performs the capping (Step S105 of FIG. 3A, FIG. 5B). In this capping, the cover member 51 covers the nozzles 421 from below by causing the ink receiving space 527 (space) open upward to face the nozzle plane 42 (nozzle surface) from below while being stopped with respect to the discharge head 4. Further, the cover member 51 includes the liquid retaining member 541 for retaining the cleaning liquid, and the liquid retaining member 541 contacts the non-nozzle plane 43 (non-nozzle surface) during the execution of the capping. Therefore, the ink can be removed from the non-nozzle plane 43 by diffusing the ink adhering to the non-nozzle plane 43 into the cleaning liquid. Moreover, since the cover member 51 is stopped with respect to the discharge head 4 during the execution of the capping, the liquid retaining member 541 continues to continuously contact the non-nozzle plane 43. Therefore, the ink can be effectively removed from the non-nozzle plane 43.

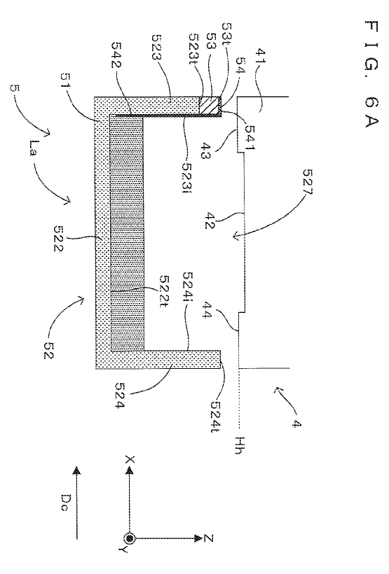

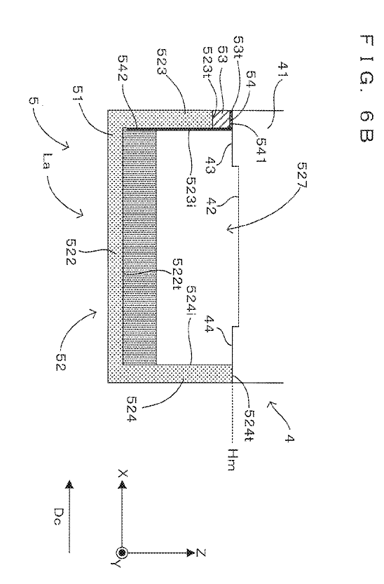

FIG. 6A is a partial sectional view schematically showing a third example of the cover member and the discharge head at the retraction height, and FIG. 6B is a partial sectional view schematically showing the third example of the cover member and the discharge head at the capping height. The state of Step S104 where the maintenance unit 5 at the facing position La is facing the discharge head 4 at the retraction height Hh from below is shown in FIG. 6A. The state of Step S105 where the maintenance unit 5 at the facing position La is facing the discharge head 4 at the capping height Hm from below (i.e. the state during the execution of the capping) is shown in FIG. 6B.

The second and third examples differ in the presence and absence of the cleaning liquid tank 55. Accordingly, the description of the third example is centered on points of difference from the second example, and common points are denoted by corresponding reference signs and the description thereof is omitted as appropriate. This is common to the description of each of the following examples.

In the cover member 51 of the third example, the cleaning liquid is stored in the cover member body 52 and at least a part of the ink receiving space 527 is filled with the cleaning liquid. The liquid supplying member 542 extends from the liquid retaining member 541 to the cleaning liquid in the cover member body 52. That is, the cleaning member 54 arranged in the conveying direction Dc along the upper surface 53t of the elastic member 53 extends downward along the inner wall surface 523i of the side plate 523 from the inner end (upstream end in the conveying direction Dc) of the upper surface 53t and reaches the cleaning liquid in the cover member body 52.

In the third example described above, the cover member body 52 (space) stores the cleaning liquid. The cover member 51 includes the liquid supplying member 542 extending from the cleaning liquid in the cover member body 52 to the liquid retaining member 541. The liquid supplying member 542 feeds the cleaning liquid to the liquid retaining member 541 from the cleaning liquid in the cover member body 52. In such a configuration, a sufficient amount of the cleaning liquid required to remove the ink from the non-nozzle plane 43 can be supplied to the liquid retaining member 541.

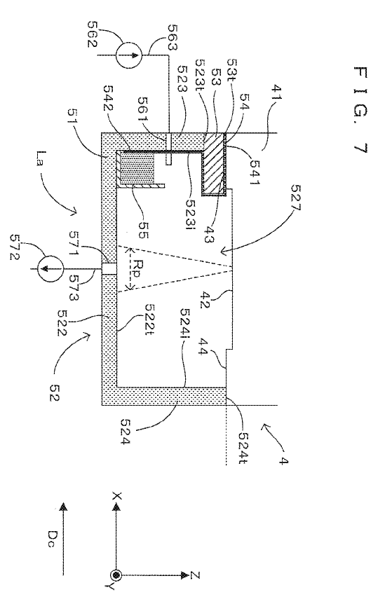

FIG. 7 is a partial sectional view schematically showing a fourth example of the cover member and the discharge head at the capping height. The fourth example differs from each of the above examples in including a support port and a discharge port for the cleaning liquid.

The cover member 51 includes a supply port 561 for supplying the cleaning liquid into the cleaning liquid tank 55. The supply port 561 is provided through the side plate 523. An entrance of the supply port 561 is open to the outside of the cover member body 52 and connected to an external supply pump 562 via a pipe 563. An exit of the supply port 561 is open above the opening of the cleaning liquid tank 55. If the supply pump 562 starts and supplies the cleaning liquid toward the entrance of the supply port 561, the cleaning liquid flowing out from the exit of the supply port 561 falls down into the cleaning liquid tank 55. In this way, the cleaning liquid is supplied to the cleaning liquid tank 55. Further, the supply pump 562 continuously supplies the cleaning liquid after the cleaning liquid stored in the cleaning liquid tank 55 becomes full, whereby the cleaning liquid overflowing from the cleaning liquid tank 55 is supplied to the upper surface 522t of the bottom plate 522 of the cover member body 52.

The cover member 51 includes a discharge port 571 for discharging the cleaning liquid from the cover member body 52. The discharge port 571 is provided through the bottom plate 522. An exit of the discharge port 571 is open to the outside of the cover member body 52 and connected to an external discharge pump 572 via a pipe 573. An entrance of the discharge port 571 is open in the upper surface 522t of the bottom plate 522. If the discharge pump 572 starts and sucks the exit of the discharge port 571, the cleaning liquid pooled on the bottom surface of the cover member body 52, i.e. the upper surface 522t of the bottom plate 522, flows out to the pipe 573 from the discharge port 571. The cleaning liquid flowing out to the pipe 573 is discarded to an unillustrated waste tank by the discharge pump 572. In this way, the cleaning liquid pooled on the bottom surface of the cover member body 52 is discharged from the cover member body 52.

In the fourth example described above, the cover member 51 includes the supply port 561 (cleaning liquid replenisher) for replenishing the cleaning liquid into the cleaning liquid tank 55. In such a configuration, a sufficient amount of the cleaning liquid required to remove the ink from the non-nozzle plane 43 can be replenished into the cleaning liquid tank 55 and supplied to the liquid retaining member 541.

Further, the cleaning liquid tank 55 is arranged inside the cover member body 52 and open upward. The supply port 561 supplies the cleaning liquid to the upper surface 522t of the bottom plate 522 (bottom surface of the cover member body 52) by causing the cleaning liquid to overflow from the cleaning liquid tank 55. In such a configuration, the ink solidified on the upper surface 522t of the bottom plate 522 can be dissolved by the cleaning liquid.

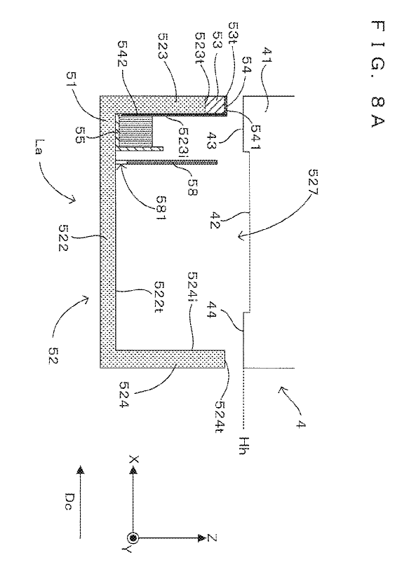

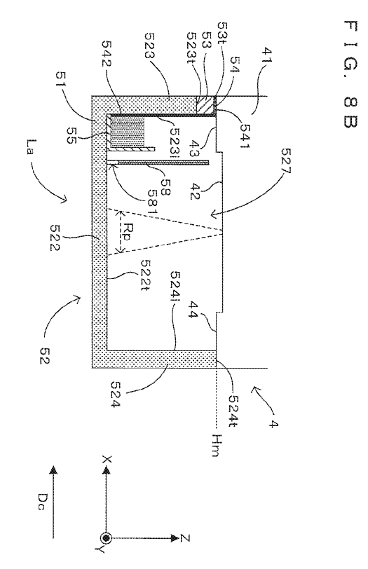

FIG. 8A is a partial sectional view schematically showing a fifth example of the cover member and the discharge head at the retraction height, and FIG. 8B is a partial sectional view schematically showing the fifth example of the cover member and the discharge head at the capping height. The fifth example differs from each of the above examples in including an ink guard.

The cover member 51 includes an ink guard 58 for suppressing the scattering of the ink flowing out from the nozzles 421 by the purging. The ink guard 58 is, for example, a plate made of resin or the like. The ink guard 58 is arranged between the cleaning liquid tank 55 and the ink passage range Rp in the conveying direction Dc and extends from the upper surface 522t of the bottom plate 522 toward an upper side of the cleaning liquid tank 55. In a view point from the upstream side in the conveying direction Dc, the ink guard 58 overlaps at least a part (entirety in this example) of the cleaning liquid tank 55. This cover member 51 is located between the ink passage range Rp and the liquid supplying member 542 in the conveying direction Dc. In the view point from the upstream side in the conveying direction Dc, the ink guard 58 overlaps at least a part of the liquid supplying member 542. Further, an opening 581 penetrates through the lower end of the ink guard 58 in the X direction. The cleaning liquid overflowing from the cleaning liquid tank 55 and falling down to the bottom plate 522 can spread on the bottom plate 522 via the opening 581 and fill at least a part of the ink receiving space 527.

In the fifth example described above, the cover member 51 includes the ink guard 58 (ink avoiding member). During the execution of the capping, the discharge head 4 performs the purging to cause the ink to flow out toward the ink receiving space 527 from the nozzles 421. The ink guard 58 is located between the ink passage range Rp, in which the ink flowing out toward the ink receiving space 527 from the nozzles 421 by the purging passes, and the liquid supplying member 542. In such a configuration, the contamination of the liquid supplying member 542 by the ink flowing out from the nozzles 421 by the purging can be suppressed by the ink guard 58. As a result, the ink can be efficiently removed from the non-nozzle plane 43 by supplying the clean cleaning liquid to the liquid retaining member 541.

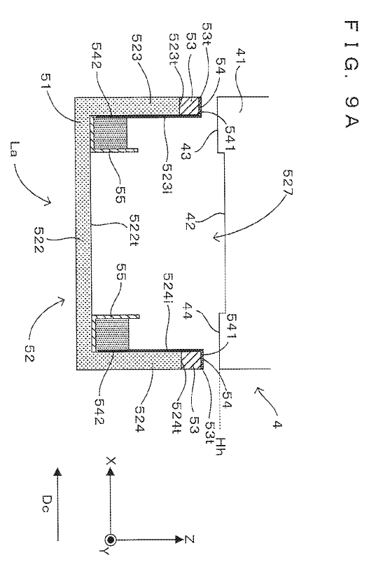

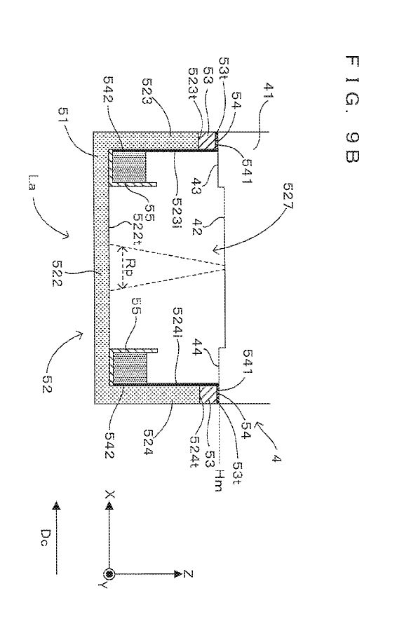

FIG. 9A is a partial sectional view schematically showing a sixth example of the cover member and the discharge head at the retraction height, and FIG. 9B is a partial sectional view schematically showing the sixth example of the cover member and the discharge head at the capping height. The sixth example differs from each of the above examples in that the elastic member 53, the cleaning member 54 and the cleaning liquid tank 55 are provided on each of the side plates 523, 524.

That is, the upper end surface 524t of the side plate 524 is provided at the same height as the upper end surface 523t of the side plate 523. As in the case of the side plate 523, the elastic member 53, the cleaning member 54 and the cleaning liquid tank 55 are arranged for the side plate 524.

In the sixth example described above, the discharge head 4 has the non-nozzle plane 43 (first non-nozzle surface) and the non-nozzle plane 44 (second non-nozzle surface). In the conveying direction Dc, the non-nozzle plane 43 is arranged downstream of (on the first side of) the nozzle plane 42, and the non-nozzle plane 44 is arranged upstream of (on the second side of) the nozzle plane 42. The cover member 51 has the upper end surface 523t (first facing part) and the upper end surface 524t (second facing part). During the capping, the upper end surface 523t is facing the non-nozzle plane 43 and the upper end surface 524t is facing the non-nozzle plane 44. The liquid retaining member 541 is arranged on each of the upper end surfaces 523t, 524t. During the execution of the capping, the liquid retaining member 541 arranged on the upper end surface 523t contacts the non-nozzle plane 43, and the liquid retaining member 541 arranged on the upper end surface 524t contacts the non-nozzle plane 44. In such a configuration, the ink can be efficiently removed from each of the non-nozzle planes 43, 44 provided on the both sides of the nozzle plane 42.

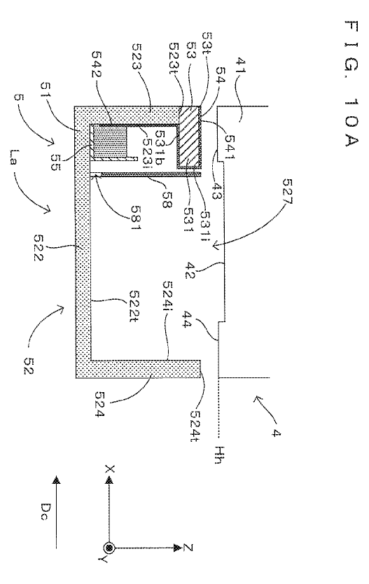

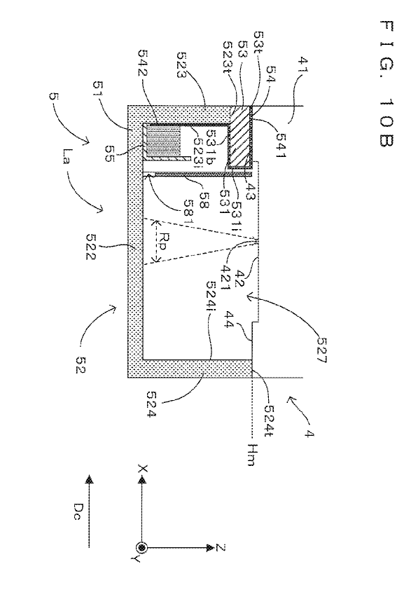

FIG. 10A is a partial sectional view schematically showing a seventh example of the cover member and the discharge head at the retraction height, and FIG. 10B is a partial sectional view schematically showing the seventh example of the cover member and the discharge head at the capping height. The seventh example differs from the first example in including an ink guard. Therefore, the description of the seventh example is centered on points of difference from the first example.

In the seventh example, the cover member 51 includes an ink guard 58 for suppressing the scattering of the ink flowing out from the nozzles 421 by the purging as in the fifth example. The ink guard 58 is, for example, a plate made of resin or the like. The ink guard 58 is arranged between the cleaning liquid tank 55 and the ink passage range Rp in the conveying direction Dc and extends from the upper surface 522t of the bottom plate 522 to an upper side of the cleaning liquid tank 55. In a view point from the upstream side in the conveying direction Dc, the ink guard 58 overlaps at least a part (entirety in this example) of the cleaning liquid tank 55. This cover member 51 is located between the ink passage range Rp and the liquid supplying member 542 in the conveying direction Dc. In the view point from the upstream side in the conveying direction Dc, the ink guard 58 overlaps at least a part of the liquid supplying member 542. Further, an opening 581 penetrates through the lower end of the ink guard 58 in the X direction. The cleaning liquid overflowing from the cleaning liquid tank 55 and falling down to the bottom plate 522 can spread on the bottom plate 522 via the opening 581 and fill at least a part of the ink receiving space 527.

In the seventh example, the inner wall surface 531i of the projecting part 531 and the ink guard 58 are provided with a gap between them in the conveying direction Dc. Further, the liquid supplying member 542 extending along the inner wall surface 531i of the projecting part 531 and the ink guard 58 are provided with a gap between them in the conveying direction Dc.

In the seventh example described above, the cover member 51 includes the ink guard 58 (ink avoiding member). During the execution of the capping, the discharge head 4 performs the purging for causing the ink to flow out toward the ink receiving space 527 from the nozzles 421. The ink guard 58 is located between the ink passage range Rp, in which the ink flowing out toward the ink receiving space 527 from the nozzles 421 by the purging passes, and the liquid supplying member 542. In such a configuration, the contamination of the liquid supplying member 542 by the ink flowing out from the nozzles 421 by the purging can be suppressed by the ink guard 58. As a result, the ink can be efficiently removed from the non-nozzle plane 43 by supplying the clean cleaning liquid to the liquid retaining member 541.

Further, in the seventh example described above, the cover member 51 includes the projecting part 531 (elastic member 53) provided on the upper end surface 523t (upper end) of the side plate 523 (side wall) to project inward from the peripheral edge of the ink receiving space 527 (i.e. inner wall surface 523i of the side plate 523). The cleaning liquid tank 55 is arranged below the projecting part 531. The liquid supplying member 542 extending from the liquid retaining member 541 is provided along the lower surface 531b of the projecting part 531 from the inner side surface 531i (side surface) of the projecting part 531 and reaches the cleaning liquid tank 55. In such a configuration, the contamination of the liquid supplying member 542 by the ink can be suppressed. As a result, the ink can be efficiently removed from the non-nozzle plane 43 by supplying the clean cleaning liquid to the liquid retaining member 541.

Note that the seventh example is not limited to the embodiment described above and can be changed as appropriate. For example, the inner wall surface 531i of the projecting part 531 and the ink guard 58 may be provided in contact with each other without being spaced apart in the conveying direction Dc. Further, the liquid supplying member 542 extending along the inner wall surface 531i of the projecting part 531 and the ink guard 58 may be provided in contact with each other without being spaced apart in the conveying direction Dc. In this case, the contamination of the liquid supplying member 542 by the ink can be more effectively suppressed. As a result, the ink can be efficiently removed from the non-nozzle plane 43 by supplying the clean cleaning liquid to the liquid retaining member 541.

In the embodiment described above, the printing medium M corresponds to an example of a “printing medium” of the disclosure, the printing apparatus 1 corresponds to an example of a “printing apparatus” of the disclosure, the nozzle 421 corresponds to an example of a “nozzle” of the disclosure, the nozzle plane 42 corresponds to an example of a “nozzle surface” of the disclosure, the non-nozzle planes 43, 44 correspond to examples of a “non-nozzle surface” of the disclosure, the discharge head 4 corresponds to an example of a “discharge head” of the disclosure, the ink receiving space 527 corresponds to an example of a “space” of the disclosure, the side plates 523, 524, 525 and 526 correspond to examples of a “side wall” of the disclosure, the cover member 51 corresponds to an example of a “cover member” of the disclosure, the liquid retaining member 541 corresponds to an example of a “liquid retaining member” of the disclosure, the non-nozzle plane 43 corresponds to an example of a “first non-nozzle surface” of the disclosure, the non-nozzle plane 44 corresponds to an example of a “second non-nozzle surface” of the disclosure, the upper end surface 523t corresponds to an example of a “first facing portion” of the disclosure, the upper end surface 524t corresponds to an example of a “second facing portion” of the disclosure, the mist collection units 14, 15 correspond to examples of a “mist collector” of the disclosure, the cleaning liquid tank 55 corresponds to an example of a “cleaning liquid storage” of the disclosure, the liquid supplying member 542 corresponds to an example of a “liquid supplying member” of the disclosure, the supply port 561 corresponds to an example of a “cleaning liquid replenisher” of the disclosure, the projecting part 531 corresponds to an example of a “projecting part” of the disclosure, the ink guard 58 corresponds to an example of an “ink avoiding member” of the disclosure, and the elastic member 53 corresponds to an example of an “elastic member” of the disclosure.

Note that the disclosure is not limited to the embodiment described above and various changes other than the aforementioned ones can be made without departing from the gist of the disclosure. For example, the material of the cleaning member 54 is not limited to a nonwoven fabric and may be a gauze or the like. That is, various materials having liquid absorbency and liquid retention property can be used as the cleaning member 54.

Further, the configuration of the discharge head 4 can be changed as appropriate, and it is not essential that the non-nozzle planes 43, 44 project downward from the nozzle plane 42.

Further, it is not essential that the liquid retaining member 541 is supported by the elastic member 53. For example, the liquid retaining member 541 may be supported by resin or the like. Further, for example, the upper end surface 523t of the side plate 523 may directly support the liquid retaining member 541. In this case, the material of the liquid retaining member 541 may be a material such as a sponge having liquid absorbency and liquid retention property and elasticity. In such a configuration, during the execution of the capping, the upper end surface 523t of the side plate 523 presses the liquid retaining member 541 against the non-nozzle plane 43 by an elastic force of the liquid retaining member 541 and the ink can be efficiently removed from the non-nozzle plane 43. In this case, the elastic member 53 is unnecessary. Note that the upper end surface 524t of the side plate 524 may directly support the liquid retaining member 541.

Further, the liquid retaining member 541 retaining the cleaning liquid may be brought into contact with the non-nozzle plane 43, and it is not essential that the cleaning liquid is supplied to the liquid retaining member 541 by the liquid supplying member 542 extending from the liquid retaining member 541 to the cleaning liquid tank 55. That is, the liquid supplying member 542 may not be provided. In this case, the cleaning liquid tank 55 is also unnecessary.

Further, the configuration of the cleaning liquid tank 55 can be changed as appropriate, and it is not essential that the cleaning liquid tank 55 is open upward.

Further, the positions and shapes of the supply port 561 and the discharge port 571 can also be changed as appropriate.

The disclosure is applicable to techniques for maintaining a discharge head for discharging an ink from a nozzle in general.

As described above, the printing apparatus may be configured so that the discharge head has each of a first non-nozzle surface and a second non-nozzle surface as the non-nozzle surface, the first non-nozzle surface is arranged on a first side of the nozzle surface and the second non-nozzle surface is arranged on a second side of the nozzle surface, the second side being opposite to the first side, in a conveying direction in which the printing medium is conveyed, an upper end of the side wall includes a first facing portion and a second facing portion, the first facing portion is facing the first non-nozzle surface and the second facing portion is facing the second non-nozzle surface during the capping, the liquid retaining member is arranged only on the first facing portion, of the first and second facing portions, and the liquid retaining member arranged on the first facing portion contacts the first non-nozzle surface during the execution of the capping. Such a configuration is effective, such as when there is a difference in degree of contamination between the first and second non-nozzle surfaces. That is, the liquid retaining member can be brought into contact with the non-nozzle surface having a large degree of contamination, i.e. the first non-nozzle surface, and the ink can be removed from the first non-nozzle surface. In this way, necessary maintenance can be performed for the non-nozzle surface while the number of the liquid retaining member is suppressed.

The printing apparatus may further comprise a mist collector sucking the ink in a misty state, wherein: the mist collector is arranged on the first side of the discharge head. In such a configuration, an air flow of ink mist to be sucked by the mist collector is generated near the first non-nozzle surface. Thus, the degree of contamination of the first non-nozzle surface is larger than that of the second non-nozzle surface. Accordingly, the ink can be removed from the first non-nozzle surface by bringing the liquid retaining member into contact with the first non-nozzle surface. In this way, necessary maintenance can be performed for the non-nozzle surface while the number of the liquid retaining member is suppressed.

The printing apparatus may be configured so that the discharge head has each of a first non-nozzle surface and a second non-nozzle surface as the non-nozzle surface, the first non-nozzle surface is arranged on a first side of the nozzle surface and the second non-nozzle surface is arranged on a second side of the nozzle surface, the second side being opposite to the first side, in a conveying direction in which the printing medium is conveyed, an upper end of the side wall includes a first facing portion and a second facing portion, the first facing portion is facing the first non-nozzle surface and the second facing portion is facing the second non-nozzle surface during the capping, the liquid retaining member is arranged on each of the first and second facing portions, and the liquid retaining member arranged on the first facing portion contacts the first non-nozzle surface and the liquid retaining member arranged on the second facing portion contacts the second non-nozzle surface during the execution of the capping. In such a configuration, the ink can be efficiently removed from each of the first and second non-nozzle surfaces provided on both sides of the nozzle surface.

The printing apparatus may be configured so that the cover member further includes a cleaning liquid storage storing a cleaning liquid and a liquid supplying member extending from the cleaning liquid storage to the liquid retaining member, and the liquid supplying member feeds the cleaning liquid from the cleaning liquid storage to the liquid retaining member. In such a configuration, a sufficient amount of the cleaning liquid required to remove the ink from the non-nozzle surface can be supplied to the liquid retaining member.

The printing apparatus may be configured so that the cover member further includes a cleaning liquid replenisher replenishing the cleaning liquid into the cleaning liquid storage. In such a configuration, a sufficient amount of the cleaning liquid required to remove the ink from the non-nozzle surface can be supplied to the liquid retaining member.

The printing apparatus may be configured so that the cleaning liquid storage is arranged inside the cover member and open upward, and the cleaning liquid replenisher supplies the cleaning liquid to a bottom part of the cover member by causing the cleaning liquid to overflow from the cleaning liquid storage. In such a configuration, the ink can be prevented from being solidified on the bottom surface of the cover member.

The printing apparatus may be configured so that the discharge head performs purging for causing the ink to flow out toward the space from the nozzle during the execution of the capping, and the cleaning liquid storage is provided at a position deviated from a range where the ink flowing out from the nozzle toward the space by the purging passes. In such a configuration, the contamination of the cleaning liquid storage by the ink flowing out from the nozzle by the purging can be suppressed. As a result, the ink can be efficiently removed from the non-nozzle surface by supplying the clean cleaning liquid to the liquid retaining member.

The printing apparatus may be configured so that the cover member further includes a projecting part provided on an upper end of the side wall to project inward from a peripheral edge of the space, the cleaning liquid storage is arranged below the projecting part, the liquid retaining member is provided on an upper surface of the projecting part, and the liquid supplying member extending from the liquid retaining member is arranged along a lower surface of the projecting part from a side surface of the projecting part and reaches the cleaning liquid storage. In such a configuration, the contamination of the liquid supplying member by the ink can be suppressed. As a result, the ink can be efficiently removed from the non-nozzle surface by supplying the clean cleaning liquid to the liquid retaining member.

The printing apparatus may be configured so that the cover member stores the cleaning liquid, the cover member further includes a liquid supplying member extending to the liquid retaining member from the cleaning liquid stored in the cover member, and the liquid supplying member feeds the cleaning liquid to the liquid retaining member from the cleaning liquid stored in the cover member. In such a configuration, a sufficient amount of the cleaning liquid required to remove the ink from the non-nozzle surface can be supplied to the liquid retaining member.

The printing apparatus may be configured so that the cover member further includes an ink avoiding member, the discharge head performs purging for causing the ink to flow out toward the space from the nozzle during the execution of the capping, and the ink avoiding member is located between a range where the ink flowing out from the nozzle toward the space by the purging passes and the liquid supplying member. In such a configuration, the contamination of the liquid supplying member by the ink flowing out from the nozzle by the purging can be suppressed. As a result, the ink can be efficiently removed from the non-nozzle surface by supplying the clean cleaning liquid to the liquid retaining member.

The printing apparatus may be configured so that the cover member includes an elastic member having elasticity, the elastic member is arranged below the liquid retaining member and supports the liquid retaining member from below, and the elastic member presses the liquid retaining member against the non-nozzle surface by an elastic force during the execution of the capping. In such a configuration, the ink can be efficiently removed from the non-nozzle surface by firmly pressing the liquid retaining member against the non-nozzle surface by an elastic force of the elastic member.

By the way, a dimensional relationship of the liquid retaining member and the non-nozzle surface can be changed as appropriate. For example, the printing apparatus may be configured so that a width of the liquid retaining member is equal to or smaller than a width of the non-nozzle surface to which the liquid retaining member contacts, and an existence range of the liquid retaining member is included in an existence range of the non-nozzle surface, in a conveying direction in which the printing medium is conveyed. The printing apparatus may be configured so that a width of the liquid retaining member is wider than a width of the non-nozzle surface to which the liquid retaining member contacts, and an existence range of the non-nozzle surface is included in an existence range of the liquid retaining member, in a conveying direction in which the printing medium is conveyed.

Note that an expression that one existence range includes another existence range in a predetermined direction means not only a case where both ends of another existence range are located between both ends of the one existence range in the predetermined direction, but also a case where at least one end of the one existence range and at least one end of the another existence range coincide.

Further, the disclosure is suitable for a printing apparatus in which the water repellency of the non-nozzle surface is lower than that of the nozzle surface. That is, the ink easily adheres to the non-nozzle surface low in water repellency, whereas the ink can be effectively removed from the non-nozzle surface.

Further, the material of the non-nozzle surface may be different from that of the nozzle surface.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A printing apparatus for discharging an ink to a printing medium, comprising:
a discharge head having a nozzle surface, in which a nozzle discharging the ink is open, and a non-nozzle surface, in which the nozzle is not open, provided adjacent to the nozzle surface; and
a cover member including a bottom surface and a side wall standing from a peripheral edge part of the bottom surface, the cover member being formed with a space open upward, the cover member configured to execute capping for covering the nozzle from below by causing the space to face the nozzle surface from below while being stopped with respect to the discharge head, wherein
the cover member includes a liquid retaining member retaining a cleaning liquid,
the liquid retaining member contacts the non-nozzle surface during the execution of the capping.

2. The printing apparatus according to claim 1, wherein:
the discharge head has each of a first non-nozzle surface and a second non-nozzle surface as the non-nozzle surface,
the first non-nozzle surface is arranged on a first side of the nozzle surface and the second non-nozzle surface is arranged on a second side of the nozzle surface, the second side being opposite to the first side, in a conveying direction in which the printing medium is conveyed,
an upper end of the side wall includes a first facing portion and a second facing portion,
the first facing portion is facing the first non-nozzle surface and the second facing portion is facing the second non-nozzle surface during the capping,
the liquid retaining member is arranged only on the first facing portion, of the first and second facing portions, and
the liquid retaining member arranged on the first facing portion contacts the first non-nozzle surface during the execution of the capping.

3. The printing apparatus according to claim 2, further comprising a mist collector sucking the ink in a misty state, wherein:
the mist collector is arranged on the first side of the discharge head.

4. The printing apparatus according to claim 1, wherein:
the discharge head has each of a first non-nozzle surface and a second non-nozzle surface as the non-nozzle surface,
the first non-nozzle surface is arranged on a first side of the nozzle surface and the second non-nozzle surface is arranged on a second side of the nozzle surface, the second side being opposite to the first side, in a conveying direction in which the printing medium is conveyed,
an upper end of the side wall includes a first facing portion and a second facing portion,
the first facing portion is facing the first non-nozzle surface and the second facing portion is facing the second non-nozzle surface during the capping,
the liquid retaining member is arranged on each of the first and second facing portions, and
the liquid retaining member arranged on the first facing portion contacts the first non-nozzle surface and the liquid retaining member arranged on the second facing portion contacts the second non-nozzle surface during the execution of the capping.

5. The printing apparatus according to claim 1, wherein:
the cover member further includes a cleaning liquid storage storing a cleaning liquid and a liquid supplying member extending from the cleaning liquid storage to the liquid retaining member, and
the liquid supplying member feeds the cleaning liquid from the cleaning liquid storage to the liquid retaining member.

6. The printing apparatus according to claim 5, wherein:
the cover member further includes a cleaning liquid replenisher replenishing the cleaning liquid into the cleaning liquid storage.

7. The printing apparatus according to claim 6, wherein:
the cleaning liquid storage is arranged inside the cover member and open upward, and
the cleaning liquid replenisher supplies the cleaning liquid to a bottom part of the cover member by causing the cleaning liquid to overflow from the cleaning liquid storage.

8. The printing apparatus according to claim 5, wherein:
the discharge head performs purging for causing the ink to flow out toward the space from the nozzle during the execution of the capping, and
the cleaning liquid storage is provided at a position deviated from a range where the ink flowing out from the nozzle toward the space by the purging passes.

9. The printing apparatus according to claim 5, wherein:
the cover member further includes a projecting part provided on an upper end of the side wall to project inward from a peripheral edge of the space,
the cleaning liquid storage is arranged below the projecting part,
the liquid retaining member is provided on an upper surface of the projecting part, and
the liquid supplying member extending from the liquid retaining member is arranged along a lower surface of the projecting part from a side surface of the projecting part and reaches the cleaning liquid storage.

10. The printing apparatus according to claim 1, wherein:
the cover member stores the cleaning liquid,
the cover member further includes a liquid supplying member extending to the liquid retaining member from the cleaning liquid stored in the cover member, and
the liquid supplying member feeds the cleaning liquid to the liquid retaining member from the cleaning liquid stored in the cover member.

11. The printing apparatus according to claim 5, wherein:
the cover member further includes an ink avoiding member,
the discharge head performs purging for causing the ink to flow out toward the space from the nozzle during the execution of the capping, and
the ink avoiding member is located between a range where the ink flowing out from the nozzle toward the space by the purging passes and the liquid supplying member.

12. The printing apparatus according to claim 1, wherein:
the cover member includes an elastic member having elasticity,
the elastic member is arranged below the liquid retaining member and supports the liquid retaining member from below, and
the elastic member presses the liquid retaining member against the non-nozzle surface by an elastic force during the execution of the capping.

13. The printing apparatus according to claim 1, wherein:
a width of the liquid retaining member is equal to or smaller than a width of the non-nozzle surface to which the liquid retaining member contacts, and an existence range of the liquid retaining member is included in an existence range of the non-nozzle surface, in a conveying direction in which the printing medium is conveyed.

14. The printing apparatus according to claim 1, wherein:
a width of the liquid retaining member is wider than a width of the non-nozzle surface to which the liquid retaining member contacts, and an existence range of the non-nozzle surface is included in an existence range of the liquid retaining member, in a conveying direction in which the printing medium is conveyed.

15. The printing apparatus according to claim 1, wherein:
water repellency of the non-nozzle surface is lower than water repellency of the nozzle surface.

16. The printing apparatus according to claim 1, wherein:
a material of the non-nozzle surface is different from a material of the nozzle surface.

17. A discharge head maintenance method, comprising:
performing capping by a cover member for a discharge head having a nozzle surface, in which a nozzle discharging the ink is open, and a non-nozzle surface, in which the nozzle is not open, provided adjacent to the nozzle surface; and
the cover member including a bottom surface and a side wall standing from a peripheral edge part of the bottom surface, the cover member being formed with a space open upward, the capping being performed by covering the nozzle from below by causing the space to face the nozzle surface from below while the cover member is stopped with respect to the discharge head,
the cover member including a liquid retaining member retaining a cleaning liquid, and
the liquid retaining member contacting the non-nozzle surface during the execution of the capping.
